(19) United States
(12) Patent Application Publication
(10) Pub. No.: US 2015/0229152 A1
(43) Pub. Date: Aug. 13, 2015

(54) Mobile Power Supply Unit

(71) Applicant: Shenzhen Hello Tech Energy Co., Ltd., Shenzhen (CN)

(72) Inventor: Meichan Wen, Shenzhen (CN)

(21) Appl. No.: 14/335,130

(22) Filed: Jul. 18, 2014

(30) Foreign Application Priority Data
Feb. 10, 2014 (CN) 201410046975.8

(51) Int. Cl. H02J 7/00; H02J 7/02

(52) U.S. Cl. CPC H02J 7/0054; H02J 7/025; H02J 7/0029

(57) ABSTRACT

A mobile power supply unit is provided for wirelessly charging electronic device ready to be recharged, the mobile power supply unit includes a battery, and also includes: a detecting module, a detecting module, configured to detect a discharging control instruction and further to detect characteristic information of the electronic device, and convert both the discharging control instruction and the characteristic information to a corresponding digital control signal; a micro-control module, connecting the detecting module, configured to, according to the digital control signal, control a wireless discharging module to charge the electronic device; the wireless discharging module, connected to the micro-control module and the battery, configured to convert electric energy of the battery to wireless electric energy, and transmit the wireless electric energy to the electronic device.

### CROSS-REFERENCE TO RELATED APPLICATIONS

This application claims priority to Chinese Application No. 201410046975.8, titled “MOBILE POWER SUPPLY UNIT”, filed on Feb. 10, 2014, which is hereby incorporated by reference in its entirety.

### FIELD OF TECHNOLOGY

The present disclosure relates to the field of power technology, and more particularly to a mobile power supply unit.

### BACKGROUND

Along with the popularity of electronic devices, users are requiring increasingly higher performance for mobile power supply units that provide power for electronic devices. Conventional mobile power supply units need a button to be pressed to control discharging process. Specifically, when a user needs to charge an electronic device which is ready to be recharged with a mobile power supply unit, he or she needs to press a button. The button is pressed to control a circuit of a wireless discharge module to be conducted. After that, the mobile power supply unit charges the electronic device. This way of operation has shown inconvenience in controlling, and the button is easy to wear out.

### SUMMARY

The present disclosure is directed to a mobile power supply unit which can control the charging without pressing a button.

A mobile power supply unit, configured to wirelessly charge an electronic device ready to be recharged, comprising a battery, and further comprising:

a detecting module configured to detect a discharging control instruction and to further detect characteristic information of the electronic device, and to convert the discharging control instruction and characteristic information into a corresponding digital control signal; and

a micro-control module, connected to the detecting module, configured to control a wireless discharging module to charge the electronic device according to the digital control signal;

wherein the wireless discharging module is connected to the micro-control module and the battery; and the wireless discharging module is configured to convert electric energy of the battery to wireless electric energy, and to transmit the wireless electric energy to the electronic device.

In one embodiment, the discharging control instruction is a shaking control instruction or a touch control instruction.

In one embodiment, the detecting module detects characteristic information of the electronic device located in a preset area.

In one embodiment, the micro-control module is configured to send a request for establishing a connection with the electronic device, and to control the wireless discharging module to charge the electronic device after receiving response information from the electronic device.

In one embodiment, the detecting module is further configured to detect an electric quantity detecting instruction, and to convert the electric quantity detecting instruction to a digital detecting signal;

the micro-control module, connected to the battery, is configured to detect electric quantity of the battery according to the digital detecting signal.

In one embodiment, the electric quantity detecting instruction is a shaking control instruction or a touch control instruction.

In one embodiment, further comprising a displaying module connected to the micro-control module and configured to display the electric quantity of the battery.

In one embodiment, the micro-control module is configured to control the wireless discharging module to charge the electronic device if characteristic information of the electronic device is detected within a preset time duration from the discharging control instruction is received by the detecting module, or else configured to disable the wireless discharging module.

In one embodiment, further comprising:

a wireless charging module, respectively connected to the battery and micro-control module, configured to receive wireless energy emitted from an external wireless electronic power supply device, and to convert the wireless energy to electric energy for charging the battery.

In one embodiment, further comprising:

an outer case configured to receive the battery, the detecting module, and the wireless discharging module, wherein the outer case is a fully sealed structure.

In one embodiment, the characteristic information is a combination of at least one kind of information including electronic device model, performance parameter of the battery attached to the electronic device, and electric quantity of the battery.

In one embodiment, the displaying module comprises at least one light emitting diode.

In one embodiment, further comprising a protecting module, one end of the protecting module is connected to a negative electrode of the battery, and the other end is grounded.

According to the mobile power supply unit mentioned above, the detecting module detects the discharging control instruction and characteristic information of the electronic device, and converts the discharging control instruction and characteristic information to a corresponding digital control signal. According to the digital control signal, the micro-control module controls the wireless discharging module to charge the electronic device. The mobile power supply unit mentioned above is easy to be operated, and also avoids an inconvenient operation way of using a button and a problem that the button is easy to wear out.

### BRIEF DESCRIPTION OF THE DRAWINGS

FIG. 1 is a schematic diagram illustrating a mobile power supply unit according to one embodiment;

FIG. 2 is a schematic diagram illustrating a mobile power supply unit according to another embodiment;

FIG. 3 is a schematic circuit diagram illustrating the wireless charging module 260 in the embodiment as shown in FIG. 2;

FIG. 4A-FIG. 4E are schematic circuit diagrams illustrating the wireless discharging module 240 in the embodiment as shown in FIG. 2.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

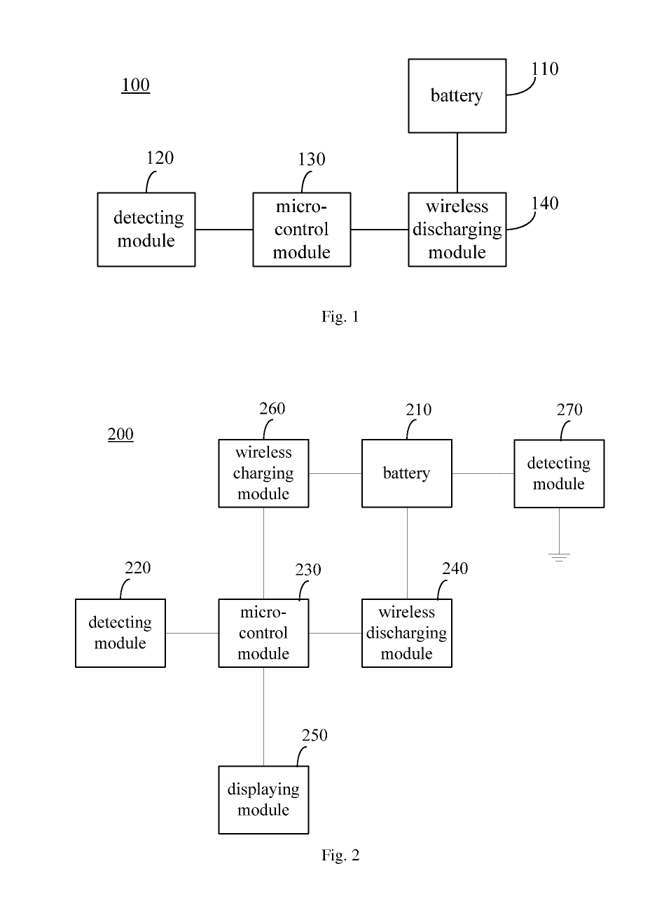

FIG. 1 is a schematic diagram illustrating a mobile power supply unit according to one embodiment.

In one embodiment as shown in FIG. 1, a mobile power supply unit 100 is provided. The mobile power supply unit 100 is used for wirelessly charging electronic devices ready to be recharged. The mobile power supply unit 100 includes a battery 110, a detecting module 120, a micro-control module 130 and a wireless discharging module 140. The detecting module 120 and the wireless discharging module 140 are respectively connected to the micro-control module 130. The wireless discharging module 140 is further connected to the battery 110.

The detecting module 120 detects a discharging control instruction, and further detects characteristic information of electronic devices ready to be recharged after the discharging control instruction is detected. The detecting module 120 converts both the detected discharging control instruction and the detected characteristic information to corresponding digital control signals, and further transmits the digital control signals to the micro-control module 130. After receiving the digital control signals mentioned above, the micro-control module 130 controls the wireless discharging module 140 to charge electronic devices ready to be recharged. The mobile power supply unit 100 according to the present embodiment is easily operational, and the problem accompanying with the traditional way of using a button which is inconveniently operational and easy to wear out can be eliminated.

More specifically, the discharging control instruction refers to an instruction of controlling the mobile power supply unit 100 to discharge. The discharging control instruction may be a shaking control instruction or a touch control instruction. In the present embodiment, the discharging control instruction refers to the shaking control instruction, which means that the discharging control instruction is sent when the mobile power supply unit 100 is shaken by a user. Shaking times, shaking frequency and duration of the shaking operation may be defined to ensure validity of the discharging control instruction. The discharging control instruction becomes valid only when the shaking times or the shaking frequency or the duration of the shaking operation respectively reaches the corresponding preset values. For example, the discharging control instruction may be set to be valid after the mobile power supply unit 100 is shaken for two times, or the shaking frequency reaches a preset frequency, or the duration of the shaking operation reaches a preset duration. In other embodiments, the discharging control instruction may be a touch control instruction. In that situation, a touch sensitive area shall be included in the mobile power supply unit 100. When it is needed to wirelessly charge the electronic device, a touch control instruction may be sent by means of touching the touch sensitive area of the mobile power supply unit 100. As the mobile power supply unit 100 mentioned above controls the process of wirelessly discharging according to the discharging control instruction, there is no need to set a button on the mobile power supply unit 100, the problem that the button is easy to wear out will not exist, thereby improving the comprehensive performance of the mobile power supply unit 100.

After having detected the discharging control instruction, the detecting module 120 detects the characteristic information of the electronic devices ready to be recharged in a preset area. Specifically, the detecting module 120 will detect an emission area of the wireless discharging module 140 to obtain the characteristic information of an electronic device when the electronic device is located in the emission area. Specifically, said electronic device has wireless receiving function. The characteristic information may be a combination of one or more kind of information including the electronic device model, the performance parameter of the battery attached to the electronic device, and the electric quantity of the battery, etc. The detecting module 120 converts both the detected characteristic information and the discharging control instruction into a corresponding digital control signal. The detecting module 120 then transmits the digital control signal to the micro-control module 130.

According to the digital control information, the micro-control module 130 controls the wireless discharging module 140 to charge the electronic devices. Specifically, after receiving the digital control signal sent by the detecting module 120, the micro-control module 130 sends a request to the electronic device ready to be recharged for establishing a connection therebetween. After response information is received from the electronic device, the micro-control module 130 controls the wireless discharging module 140 to charge the electronic device. Through the way of requesting and responding, the electronic device will be charged only after responding the request, thus preventing electronic devices locating in the wireless emission area from being unwantedly charged, thereby saving the electric quantity of the mobile power supply unit 100, and further improving the charging efficiency of the mobile power supply unit 100 for the electronic devices.

In present embodiment, the micro-control module 130 begins timing after receiving the digital control signal sent by the detecting module 120. When a timing duration reaches a preset duration value while no characteristic information of the electronic device ready to be recharged is not detected by the detecting module 120, the micro-control module 130 will control the wireless discharging module 140 not to work, in other words, the mobile power supply unit 100 is closed. In the process of using the mobile power supply unit 100, when the discharging control instruction is detected while no electronic device is present in the emission area, the detecting module 120 will continuously detect electronic device in the emission area, causing unnecessary energy waste. Through setting a preset duration for the micro-control module 130, this unwanted energy consumption coming from the misoperation can be eliminated. The preset duration value may be set by practice. In preset embodiment, the preset duration is thirty seconds.

According to the mobile power supply unit 100, the detecting module 120 detects the discharging control instruction and characteristic information of electronic devices ready to be recharged, and converts both the discharging control instruction and characteristic information into a corresponding digital control signal. The micro-control module 130 controls the wireless discharging module 140 to charge the electronic devices according to the digital control signal. The mobile power supply unit 100 is easily operational, inconvenient operation of using a button can be avoided and the problem that the button is easy to wear out can be solved.

In another embodiment, the detecting module 120 of the mobile power supply unit 100 is also used for detecting an electric quantity detecting instruction. The electric quantity detecting instruction refers to an instruction for detecting electric quantity of the mobile power supply unit 100, the electric quantity detecting instruction can be a shaking control instruction or a touch control instruction. The detecting module 120 converts the electric quantity detecting instruction into a corresponding digital detecting signal and transmits the digital detecting signal to the micro-control module 130. The micro-control module 130 detects electric quantity of the battery 110 according to the digital detecting signal sent by the detecting module 120. In the present embodiment, the electric quantity detecting instruction refers to a shaking control instruction. When it is needed to detect electric quantity of the battery 110, the user only needs to shake the mobile power supply unit 100. Time, frequency or duration of the shaking operation may be set to ensure validity of the shaking control instruction. The shaking control instruction can be recognized as valid only when the time or the frequency of the shaking operation reaches a preset value or the duration of the shaking operation reaches a preset duration, whereas accordingly the detecting module 120 will convert the shaking control instruction to a corresponding digital detecting signal and transmit the corresponding digital detecting signal to the micro-control module 130.

In the present embodiment, in case both the discharging control instruction and electric quantity detecting instruction are shaking control instructions, there shall be a way to distinguish the two kinds of shaking control instructions. Specifically, the two kinds of shaking control instructions may be distinguished through shaking times, for example, shaking one time refers to the electric quantity detecting instruction, and shaking two times refers to the discharging control instruction. Otherwise, the two kinds of shaking control instructions may be distinguished through duration time of the shaking operation, for example, shaking for a first duration time refers to the electric quantity detecting instruction, and shaking for a second duration time refers to the discharging control instruction. The method of distinguishing the discharging control instruction from the electric quantity detecting instruction is not limited in the methods mentioned above, while other more reasonable approaches may be adopted. In other embodiments, the discharging control instruction and the electric quantity detecting instruction may be set in different control modes, for example, when the discharging control instruction refers to the shaking control instruction, the electric quantity detecting instruction can refer to the touch control instruction, or vice versa.

FIG. 2 is a schematic diagram illustrating a mobile power supply unit according to another embodiment.

In present embodiment as shown in FIG. 2, the mobile power supply unit 200 mentioned above includes a battery 210, a detecting module 220, a micro-control module 230, a wireless discharging module 240 and a displaying module 250. The displaying module 250, connected to the micro-control module 230, is used for displaying the electric quantity of the battery 210. The micro-control module 230 detects electric quantity of the battery 210 according to a digital detecting signal sent by the detecting module 220, and then controls the displaying module 250 to display the electric quantity of the battery 210. The displaying module 250 includes at least one light emitting diode (LED). In the present embodiment, the displaying module 250 includes three LEDs, the electric quantity of the battery 210 is indicated by the number of the lighten LEDs. For example, three all lighten LEDs indicate the electric quantity of the battery 210 to be more than two-thirds; two lighten LEDs indicate the electric quantity of the battery 210 to be between one-third to two-thirds; only one lighten LED indicates the electric quantity to be below one-third. In other embodiments, the displaying module 250 may use different number of LEDs to represent the electric quantity of the battery 210. Wherein, color of light emitting diodes may be the same or different. When the micro-control module 230 controls the displaying module 250 to display the electric quantity of the battery 210, meanwhile, the micro-control module 230 starts timing. When a duration time of the timing reaches a preset displaying duration time, the micro-control module 230 controls the displaying module 250 to turn off. Electronic energy waste of long time displaying of the displaying module 250 may be avoided by setting the displaying duration time of the displaying module 250. In the present embodiment, the displaying duration time is thirty seconds.

In another embodiment, when the micro-control module 230 controls the wireless discharging module 240 to charge the electronic devices, the micro-control module 230 also controls the displaying module 250 to display electric quantity of the battery 210. The displaying module 250 can timely indicate the electric quantity of the battery 210 in the process of charging, so as to remind the user to charge the mobile power supply unit 200 when the electric quantity of the battery 210 is insufficient.

As shown in FIG. 2, the mobile power supply unit 200 also includes a wireless charging module 260 and a protecting module 270, the wireless charging module 260 is respectively connected to the battery 210 and the micro-control module 230. The wireless charging module 260 is used for receiving wireless energy sent by an external wireless power supply device and converting the wireless energy to electric energy for charging the battery 210. Specifically, when it is needed to charge the mobile power supply unit 200, the mobile power supply unit 200 is put into the emission area of an external wireless power supply device, the wireless charging module 260 can wirelessly charge the battery 210 by starting up the external wireless power device. In the present embodiment, the wireless charging module 260 includes a receiving coil and an integrated control chip, the receiving coil is used for converting the wireless energy sent by the external wireless power supply device to electric energy, thus charging the battery 210 with constant-current and constant-voltage through controlling of the integrated control chip.

In the present embodiment, the mobile power supply unit 200 further includes a protecting module 270. The protecting module 270 is connected to the battery 210, negative electrode of the battery 210 is grounded through connection to the protecting module 270. The protecting module 270 is used for protecting the battery 210 from being overcharged, being over discharged, over current or short circuit. Specifically, the protecting module 270 includes a protecting chip and two NMOS transistors. The two NMOS transistors are controlled by the protecting module 270 to be conductive or shut down, so as to protect the battery 210 from being overcharged, being over discharged, over current or short circuit, thereby preventing the battery 210 from wearing out when control of charging/discharging is abnormal.

The mobile power supply unit 200 also includes an outer case (not shown), which is used for receiving the battery 210, the detecting module 220, the micro-control module 230, the wireless discharging module 240, the displaying module 250, the wireless charging module 260 and the protecting module 270, etc. The mobile power supply unit 200 wirelessly receives and wirelessly transmits electric energy respectively through the wireless charging module 260 and the wireless discharging module 240, the discharging thereof can be controlled according to the detecting module 220. Accordingly, the mobile power supply unit 200 requires no open interface, and the structure of the outer case is fully sealed. The outer case with the fully sealed structure can bring dust prevention and water proofing, and reduce the probability of accidental wearing out, thereby improving the comprehensive performance. A design without an open interface can avoid problems of aging, wearing out and scathing, which are caused of long-term plugging in and/or out. The mobile power supply unit 200 charges and discharges wirelessly without the need of a power line, which is conveniently operational. In the present embodiment, the outer case may be set as partially transparent. The status of the LEDs in the displaying module 250 can be seen through the transparent area, so as to check the electric quantity of the battery 210.

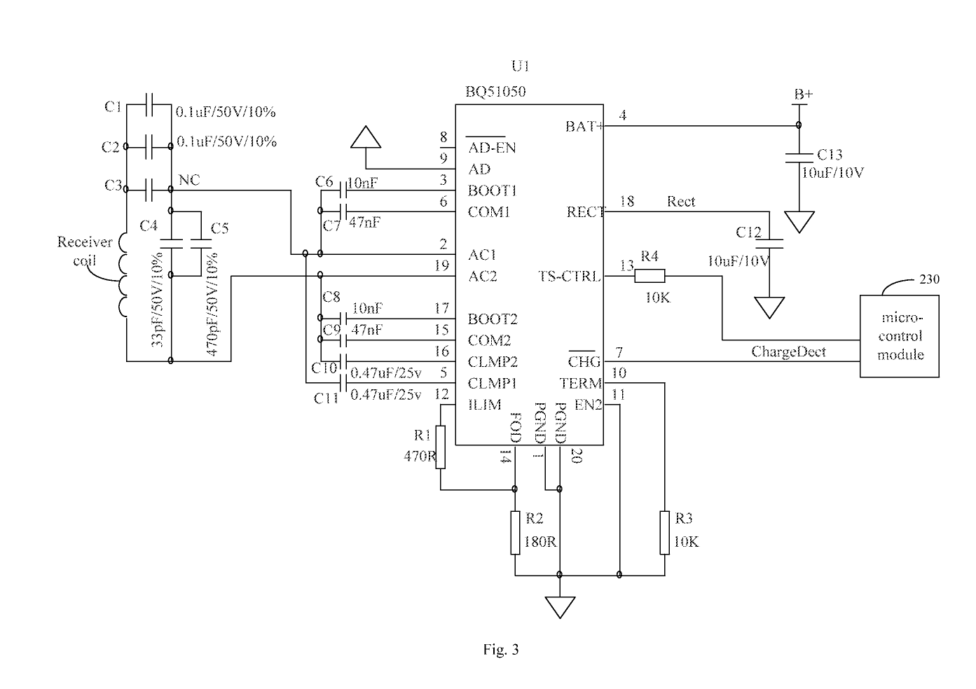

FIG. 3 is a schematic circuit diagram illustrating the wireless charging module 260 in the embodiment as shown in FIG. 2.

As shown in FIG. 3, the wireless charging module 260 is used for receiving the wireless energy emitted by the external wireless power supply devices and converting the wireless energy to electric energy for charging the battery 210. Specifically, the receiving coil converts the received wireless energy into electric energy, and then the electric energy is transmitted to the integrated control chip U1 through a resonant circuit which includes resonant capacitors C1, C2, C3, C4 and C5. The integrated control chip U1 is used for adapting the voltage of the inputted electric energy into a voltage within the charging voltage range of the battery 210, which is further used for constant-current and constant-voltage charging the battery 210. Wherein, a model of the integrated control chip can be BQ51050. In the present embodiment, the wireless charging module 260, in compliance with a standard of wireless power consortium WPC V1.1 Qi, can correctly establish communication and energy transmission with external wireless power devices. The charging state output pin, which is pin 7 of the integrated control chip U1, is connected to the micro-control module 230. When the wireless charging module 260 wirelessly charges the battery 210, the charging state output pin, which is pin 7, outputs a low level. According to the received low level signal, the micro-control module 230 controls LEDs of the displaying module 250 to be lighted to indicate the charging state.

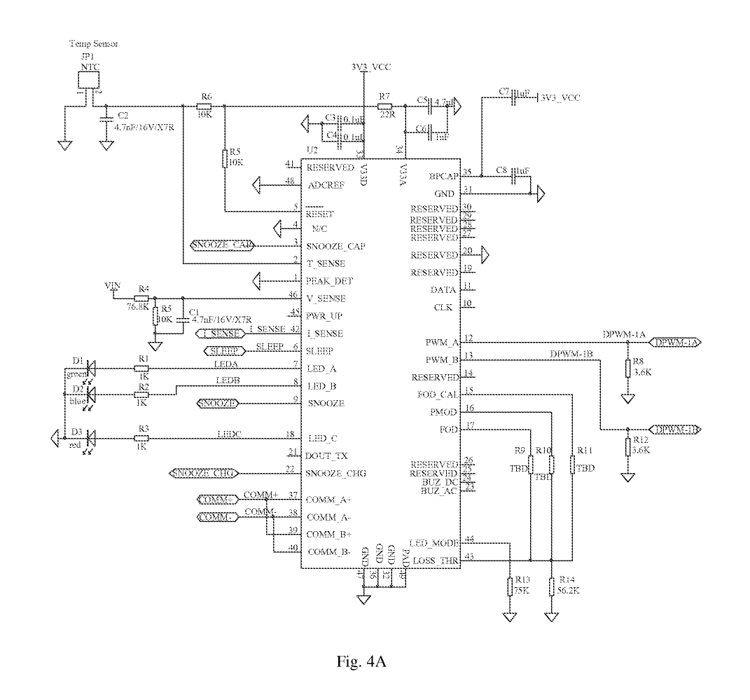

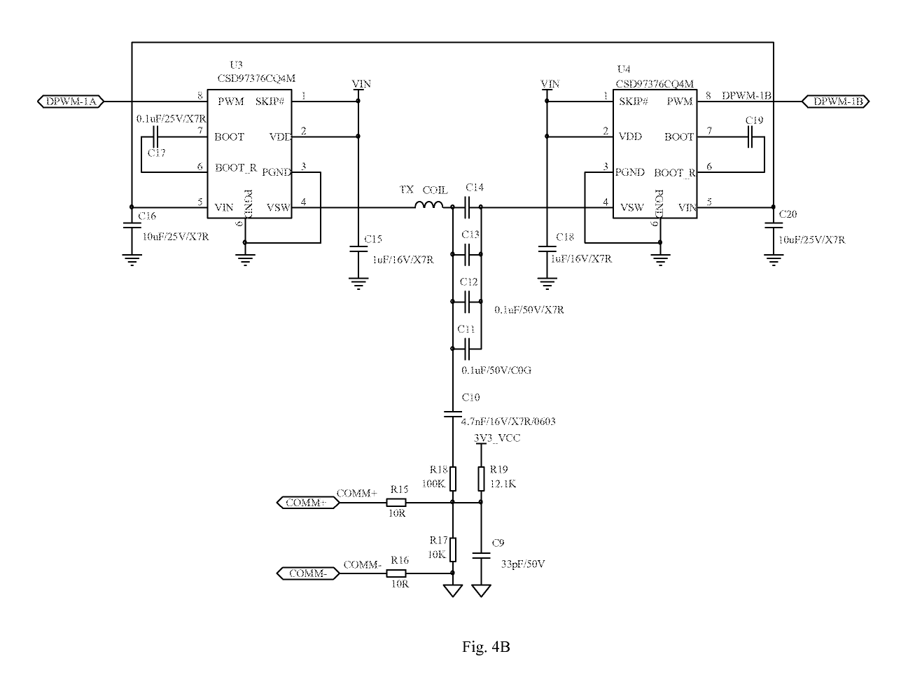

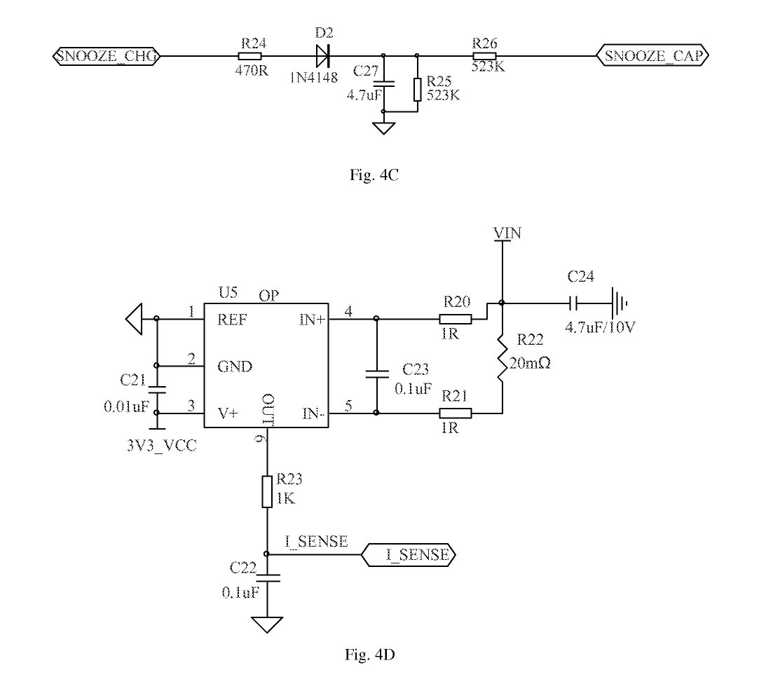

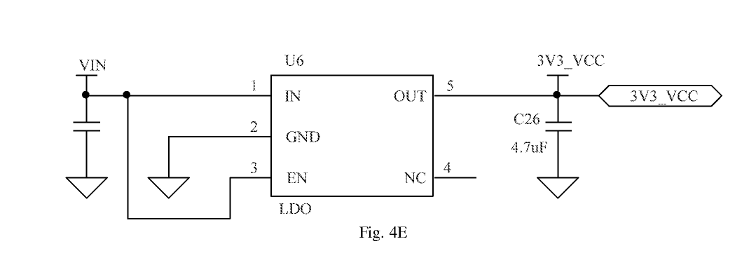

FIG. 4A-FIG. 4E are schematic diagrams illustrating the wireless discharging module 240 in the embodiment as shown in FIG. 2. As shown in FIG. 4A-FIG. 4E, the wireless discharging module 240 is used for converting electric energy of the battery 210 into wireless energy and transmitting out to charge electronic devices.

In the present embodiment, the wireless discharging module 240 includes an integrated control chip U2. Specifically, model number of the integrated control chip U2 is BQ500212A. Pin 37 and pin 39 of the integrated control chip U2 are connected as positive communication pins COMM+, pin 38 and pin 40 of the integrated control chip U2 are connected as negative communication pins COMM−. The positive and negative communication pins are connected to the transmitter coil TX COIL respectively through serially connecting a divider resistor. The positive and negative communication pins are used for establishing a communication connection with electronic devices ready to be recharged, and transmitting corresponding data of the electronic devices, such as required energy, etc, to the integrated control chip U2. According to the corresponding data inputted of the positive and negative communication pins, the integrated control chip U2 processes outputted pulse width modulated signals, and outputs the pulse width modulated processed to pin 8 of a power control chip U3 and pin 8 of a power control chip U4 respectively through pin 12 and pin 13 thereof. Wherein, pin 4 of the power control chip U3 and pin 4 of power control chip U4 are respectively connected to one end of the transmitter coil TX COIL. After receiving the pulse width modulated signal, the power control chips U3 and U4 adapt output power of the transmitter coil TX COIL according to the pulse width modulated signal. The transmitter coil works and emits wireless energy externally for charging electronic devices ready to be recharged in the emitting area. Wherein, model numbers of both the power control chip U3 and U4 are CSD97376CQ4M. One end of the transmitter coil serially connects a harmonic unit which includes multiple harmonic capacitances in parallel. To attain a required waveform for the electronic device to be charged, the harmonic unit can adapt output waveform.

Pins 7, 8 and 18 of the integrated control chip U2 are respectively connected to LEDs D1, D2 and D3 through respectively connecting a current-limiting resistance in serial, and then ground. The LEDs DE D2 and D3 are used for indicating state of the wireless discharging module 240, for example, the LED D1 is lighten to show that there are electronic devices ready to be charged in the emission area of the wireless discharging module 240; the LED D2 is lighten to show a fault state. In the present embodiment, D1 is a green LED, D2 is a blue LED and D3 is a red LED. In other embodiments, the LEDs may be set as other colors, and quantity of the LEDs is not limited to three as shown in present embodiment.

Pins 22 and 3 of the integrated control chip U2 are respectively connected to an input end “SNOOZE_CHG” and an output end “SNOOZE_CAP” of an interval emitting control circuit. Wherein, one embodiment of the interval emitting control circuit is shown in FIG. 4C. One end of a resistor R24 connects the input end “SNOOZE_CHG”, the other end of the resistor R24 connects an anode of a switching diode D2, the cathode of the switching diode D2 respectively connects a capacitor C27, a resistor R25 and a resistor R26. Wherein, the resistor R25 and the capacitor C27 are connected in parallel before being grounded, the other end of the resistor R26 is connected to the output end SNOOZE_CAP of the interval control circuit. In the present embodiment, discharging time of the discharging circuit, which is composed of the capacitor C27 and the resistor R25, can be controlled by adjusting the capacitor C27 and the resistor R25, so as to control interval emitting duration of the transmitter coil. The interval emitting control circuit mainly works during the primary work stages of the wireless discharging module 240 when position of the electronic device need to be adjusted since relative position between the electronic device to be recharged and the mobile power supply unit 200 is not optimal. During this adjustment, unnecessary consumption of electric energy will occur if the transmitter coil TX COIL is always in an emitting status. The interval emitting control circuit can control the transmitter coil TX COIL to work in interval until the electronic device to be recharged and the wireless discharging module 240 have established a correct communication connection. After the electronic device to be recharged and the wireless discharging module 240 have established a correct communication connection, the wireless discharging module 240 goes into a normal status and the interval emitting control circuit is shut off. In the present embodiment, the interval emitting duration is in a time range of 0.4 seconds to 0.6 seconds. In other embodiments, the interval emitting duration can be reasonably adjusted.

Pin 42 of the integrated control chip U2, connected to a current sensing circuit, is used for real-time detecting and adjusting current in the process of wirelessly discharging. Wherein, the current sensing circuit is shown in FIG. 4D. Specifically, the current sensing circuit includes an operational amplifier U5.

The wireless discharging module 240, in accordance with a standard of wireless discharging consortium WPC V1.1 Qi, can establish a correct communication and transmit energy with wireless receiving devices.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A mobile power supply unit, configured to wirelessly charge an electronic device ready to be recharged, comprising:
a battery;
a detecting module configured to detect a discharging control instruction and to further detect characteristic information of the electronic device, and to convert the discharging control instruction and characteristic information into a corresponding digital control signal; and
a micro-control module, connected to the detecting module, configured to control a wireless discharging module to charge the electronic device according to the digital control signal;
wherein the wireless discharging module is connected to the micro-control module and the battery; and the wireless discharging module is configured to convert electric energy of the battery to wireless electric energy, and to transmit the wireless electric energy to the electronic device.

2. The mobile power supply unit according to claim 1, wherein the discharging control instruction is a shaking control instruction or a touch control instruction.

3. The mobile power supply unit according to claim 1, wherein the detecting module detects characteristic information of the electronic device located in a preset area.

4. The mobile power supply unit according to claim 1, wherein the micro-control module is configured to send a request for establishing a connection with the electronic device, and to control the wireless discharging module to charge the electronic device after receiving response information from the electronic device.

5. The mobile power supply unit according to claim 1, wherein the detecting module is further configured to detect an electric quantity detecting instruction, and to convert the electric quantity detecting instruction to a digital detecting signal;
the micro-control module, connected to the battery, is configured to detect electric quantity of the battery according to the digital detecting signal.

6. The mobile power supply unit according to claim 5, wherein the electric quantity detecting instruction is a shaking control instruction or a touch control instruction.

7. The mobile power supply unit according to claim 5, further comprising a displaying module connected to the micro-control module and configured to display the electric quantity of the battery.

8. The mobile power supply unit according to claim 1, wherein the micro-control module is configured to control the wireless discharging module to charge the electronic device if characteristic information of the electronic device is detected within a preset time duration from the discharging control instruction is received by the detecting module, or else configured to disable the wireless discharging module.

9. The mobile power supply unit according to claim 1, further comprising:
a wireless charging module, respectively connected to the battery and micro-control module, configured to receive wireless energy emitted from an external wireless electronic power supply device, and to convert the wireless energy to electric energy for charging the battery.

10. The mobile power supply unit according to claim 1, further comprising:
an outer case configured to receive the battery, the detecting module, and the wireless discharging module, wherein the outer case is a fully sealed structure.

11. The mobile power supply unit according to claim 3, wherein the characteristic information is a combination of at least one kind of information including electronic device model, performance parameter of the battery attached to the electronic device, and electric quantity of the battery.

12. The mobile power supply unit according to claim 7, wherein the displaying module comprises at least one light emitting diode.

13. The mobile power supply unit according to claim 1, further comprising a protecting module, one end of the protecting module is connected to a negative electrode of the battery, and the other end is grounded.
